(19) United States
(12) Patent Application Publication
(10) Pub. No.: US 2008/0000746 A1
(43) Pub. Date: Jan. 3, 2008

(54) DRIVETRAIN ARRANGEMENT AND METHOD FOR OPERATING A DRIVETRAIN ARRANGEMENT

(75) Inventors: Peter Schiele, Kressbronn (DE); Georg Gierer, Kressbronn (DE); Christian Popp, Kressbronn (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/766,854

(22) Filed: Jun. 22, 2007

(30) Foreign Application Priority Data
Jun. 29, 2006 (DE) 10 2006 030 040.8

(51) Int. Cl. B60W 10/02; F16D 45/00

(52) U.S. Cl. 192/3.54; 180/65.2; 192/48.4; 903/945; 903/912

(57) ABSTRACT

A vehicular parallel hybrid drivetrain contains a combustion engine, electric motor and drive output and a method of operating the drivetrain. A respective shift element device (6, 7) with continuously variable transmission capacity is provided, between the combustion engine and the electric motor and between the electric motor and the drive. The shift element device (6), between the combustion engine and electric motor, comprises a speed-dependent hydraulic coupling element and a frictional shift element in a parallel power branch. The shift element device (6) has continuously adjustable transmission capacity and is bridged, via the hydraulic coupling element. The hydraulic coupling element actively couples with the electric motor, via a free-wheel overrunning connection (8). This coupling disengages when the speed of the coupling element side of the coupling element is lower than the speed of the electric motor in the area of the free-wheel overrunning connection.

This application claims priority from German Application Serial No. 10 2006 030 040.8 filed Jun. 29, 2006.

### FIELD OF THE INVENTION

The invention concerns a drivetrain arrangement and a method for operating a drivetrain arrangement.

### BACKGROUND OF THE INVENTION

Vehicles known from common practice that have drivetrain arrangements, such as parallel hybrid drivetrains, are usually formed with a shift element mechanism, such made as a frictional clutch, arranged between a combustion engine and the drive output of the vehicle in order to be able to start up the vehicle by way of the combustion engine in a known manner. The starting element is at first operated in a slipping mode during a start-off process. When starting off solely by way of an electric motor of a hybrid vehicle, there is no need for the controlled and regulated slipping operation of the starting element since, in contrast to conventional combustion engines, electric motors have no minimum rotation speed.

From DE 10 2004 002 061 A1, a method for the control and regulation of a drivetrain of a hybrid vehicle and a drivetrain of a hybrid vehicle made with a frictional starting element or with a frictional shift element arrangement are known. The invention discloses a combustion engine, having an electric motor, and a shift element, made with continuously variable transmission capacity, arranged between the electric motor and the drive output in a force flow of the drivetrain. A coupling device is arranged between the electric motor and the combustion engine, by way of which the electric motor and the combustion engine can be brought into active connection. By way of the method according to the invention for controlling and regulating a drivetrain, the drivetrain of a hybrid vehicle can be operated in such manner that a transition from driving the hybrid vehicle, by way of the electric motor, to parallel driving of the hybrid vehicle, by the electric motor and the combustion engine or to driving the hybrid vehicle purely by way of the combustion engine and starting the combustion engine by way of the electric motor, can be carried out without any reaction torque of the drivetrain that is perceptible by a driver of the hybrid vehicle.

For this purpose, during the operation of the drivetrain, the transmission capacity of the shift element between the electric motor and the drive output is adjusted during a starting process of the combustion engine in such a manner that a torque, independent of the starting process of the combustion engine, is applied to the drive output of the drivetrain. This allows torque variations at the drive output, occurring because of the starting of the combustion engine, are preferably avoided by operating the shift element in a slipping mode.

In this method, the speed of the electric motor during the starting phase of the combustion engine is increased to a value at which the shift element between the electric motor and the drive output of the drivetrain, is ensure to be kept in slipping operation throughout the starting process of the combustion engine. The speed value is calculated by an algorithm implemented in the engine control system, the transmission control system and/or a superposed torque management system.

In addition, from the prior art, parallel hybrid drivetrains of vehicles are known, which are made, in the area between the electric machine and the drive output or a transmission device for producing various transmission ratio steps with a starting element in the form of a hydrodynamic torque converter and with a frictional shift element arranged parallel thereto and acting as a converter bridging clutch, while in the area between the electric motor and the combustion engine, a frictional shift element is provided, which enables the combustion engine to be coupled to the electric motor side of the drivetrain.

However, the known parallel hybrid drivetrain concepts, described above, have the disadvantage that in particular operating situations, a vehicle can only be started by way of a starting device made as a frictional clutch, which however, is comfort-critical over the entire lifetime of the vehicle. Furthermore, certain operating situations of a vehicle, such as prolonged slow movement during a hill climb, give rise to critical stresses for the frictional shift elements of a parallel hybrid drivetrain. In addition, the known parallel hybrid drivetrain concepts disadvantageously allow only a very limited emergency driving or emergency starting ability, since the frictional shift elements, located between the combustion engine and the electric motor or between the electric motor and the drive output in most hybrid concepts, are operated by a hydraulic control system whose functionality, in the event of a system failure, is either only available to a very limited extent or completely unavailable.

Accordingly, the purpose of the present invention is to provide a drivetrain arrangement and a method for the operation of a drivetrain arrangement, which allows a drivetrain arrangement or a parallel hybrid drivetrain, for a vehicle to be operated in any operating situation with the least possible stress on the shift element devices.

### SUMMARY OF THE INVENTION

According to the invention, the drivetrain arrangement, which is preferably formed as a parallel hybrid drivetrain for a vehicle with a combustion engine, an electric motor and a drive output, extends between the combustion engine and the electric motor and between the electric motor and the drive output, in each case with a shift element device of continuously variable transmission capacity. The shift element device, between the combustion engine and the electric motor, comprises a hydraulic coupling element with a speed-dependent characteristic and a frictional shift element, which is arranged in a power branch parallel to the hydraulic coupling element, whose transmission capacity is continuously adjustable and by way of which the hydraulic coupling element can be bridged across, such that the half of the hydraulic coupling element associated with the electric machine is in active connection with the electric motor, via a free-wheel overrunning connection. The active connection being released when the speed of the coupling element portion, on the electric motor side, is lower than the speed of the electric motor in the area of the said free-wheel overrunning connection.

In a simple manner, this provides the possibility that in a vehicle made with the drivetrain, according to the invention, a starting condition can be carried out with the aid of drive torque produced by the combustion engine, when the charge condition of an electric accumulator associated with the electric motor is such that the starting process cannot be carried out or cannot be carried out solely by the electric motor. In this, the drive torque of the combustion engine is passed through the hydraulic coupling element, with a speed-dependent characteristic, in the direction of the drive output without having to operate the frictional shift element of the shift element device, between the combustion engine and the electric motor, in a slip operation mode that results in high friction loading of the frictional shift element.

Besides the so-termed emergency start, when the energy accumulator is drained, the use of the inventive drivetrain arrangement also enables emergency starting to be carried out in a simple manner when the electric control system of a transmission device has failed. In transmission devices, when the electric transmission control system has failed, appropriate actuation of pressure regulators and actors allows, a so-termed, emergency gear to be engaged such that the vehicle can be started by the combustion engine, via the hydraulic coupling element and the emergency gear, which is engaged in the transmission device.

Furthermore, so-termed prolonged crawling operation of a vehicle can be carried out by way of the hydraulic coupling element, again with considerably lower friction loading of the frictional shift element of the shift element device between the combustion engine and the electric motor, because the drive torque can be transmitted from the combustion engine essentially without wear, in such operating situations of a vehicle, via the hydraulic coupling element, in the direction of the drive output of the drivetrain arrangement.

In addition, a summation of the drive torques of the combustion engine and the electric motor can be effected by way of the hydrodynamic characteristic of the hydraulic coupling element, particularly in starting processes of a vehicle during which the driver requires a high starting power, in a manner that ensures great driving comfort, since irregularities in the variation of the drive torque of the combustion engine, in the area of the hydrodynamic coupling element, are damped and the influence of the drive behavior of the combustion engine on driving comfort is reduced to a certain extent. This last-mentioned decoupling also has a positive effect on driving comfort during load changes in the drivetrain arrangement according to the invention.

Since the coupling element portion of the hydraulic coupling element associated with the electric motor is in active connection with the electric motor, via the free-wheel overrunning connection, conveyance of a braking torque from the combustion engine into the power path of the drivetrain arrangement, during purely electric motor driving or at a speed of the electric motor higher than the speed of the combustion engine, is prevented by decoupling the hydrodynamic characteristic of the hydraulic coupling element while, at the same time, the frictional shift element of the shift element device is completely disengaged, between the combustion engine and the electric motor. Moreover, by way of the free-wheel overrunning connection and completely disengaged frictional shift element, the vehicle can be operated in a so-termed coasting mode, during which a vehicle is moved in an energy-saving manner, without drive torque being produced by the combustion engine or the electric motor.

The frictional shift element of the shift element device, positioned between the combustion engine and the electric motor, can be used as a so-termed flywheel start clutch during an electric motor driven starting process or switch-on process of the combustion engine and as a variable-slip bridging clutch of the hydraulic clutch element during a process of equalizing the speeds of the combustion engine and the electric motor. In addition, continuous slip regulation can be carried out by way of the frictional element in order to reduce or completely eliminate influences of the hydrodynamic or speed-dependent characteristic of the hydraulic coupling element and to transfer load from the electric motor to the combustion engine, comfortably and in a simple manner.

In an advantageous further development of the drivetrain arrangement according to the invention, at least one device for damping speed irregularities or a torsional damper is arranged between the hydraulic coupling element and/or the frictional shift element and the electric motor and/or between the combustion engine and the coupling element and/or the frictional shift element where, during combustion engine driven propulsion, a further oscillation decoupling possibility is made available in addition or alternatively to a slip regulation of the frictional element associated with the hydraulic clutch element.

Moreover, in a vehicle made with the inventive drivetrain arrangement, there exists the possibility of not having to start by way of a shift element device, which is made as a frictional shift element, at low operating temperatures of the drivetrain arrangement, when the electric accumulator associated with the electric motor is at the minimum capacity for a starting process driven purely by the electric motor.

In a further advantageous design of the drivetrain arrangement according to the invention, the shift element device, arranged between the electric motor and the drive output, is made as a shift clutch of a transmission device, which reduces the system complexity of the drivetrain arrangement in that, compared with conventional drivetrains, the drivetrain arrangement according to the invention has no additional shift element which would require an extension of a hydraulic system of a transmission device, in particular the hydraulic control unit and the provision of ducts.

This is enabled, among other things, by the use of the hydraulic coupling element in the area between the combustion engine and the electric motor, since it reduces the need for a transmission-internal clutch or a transmission-internal frictional shift element even when the electric accumulator has run down and even during prolonged crawl operating conditions of the vehicle when driving uphill, whereby charging of the electric accumulator, associated with the electric motor during crawl operation of the vehicle, can be carried out by way of so-termed special operating strategies.

In a simple manner, this provides the possibility of making the size of the transmission-internal shift element device, made as a frictional shift element between the electric motor and the drive output, smaller than in conventional drivetrain arrangements. This means that the transmission-internal shift element need only be designed for slipping operation during a starting process of the combustion engine and/or only for a predefined upper limit of a drive torque of the electric motor.

In a further advantageous design of the inventive drivetrain arrangement, a main transmission pump device can be driven by a transmission input shaft of the transmission device and by another electric motor, such that the transmission input shaft is in active connection, via another free-wheel overrunning connection, with a part of the main transmission pump device that has to be driven in order for the main transmission pump device to develop any delivery power, which opens when the speed of the pump impeller wheel is higher than the speed of the transmission input shaft. This improves the availability of the vehicle when the energy accumulator balance is still appropriate and the electrification of the mechanical main transmission pump device has failed, since the main transmission pump device can be driven by the electric motor, via the transmission input shaft. The hydraulically actuated shift elements of a transmission device in the drivetrain arrangement can be pressurized with a control pressure by the main transmission pump device and the frictional shift element of the shift element device, between the combustion engine and the electric motor, can also be actuated for a so-termed emergency start of the combustion engine. Thus, appropriate control of the transmission-internal shift elements enables emergency starting, which is not possible with conventional drivetrain arrangements in the event of a failure.

In the method according to the invention for the operation of a drivetrain arrangement for purely electric motor driving, the frictional shift element of the shift element device, between the electric motor and the combustion engine, is disengaged and the shift element device, between the electric motor and the drive output, is engaged. Then, the entire drive torque produced by the electric motor is available for driving a vehicle made with the inventive drivetrain arrangement. The friction loading of the shift element device arranged between the electric motor and the drive output is minimized by comparison with slipping operation.

In a further embodiment of the method according to the invention, the frictional shift element of the shift element device, between the electric motor and the combustion engine is disengaged in a controlled and regulated manner, during an electric motor powered starting process of the combustion engine. The shift element device, between the electric motor and the drive output, is preferably operated in slipping mode so that no reaction torques, that affect adverse driving comfort, are produced at the drive output by starting the combustion engine.

A further embodiment of the inventive method provides that the frictional shift element of the shift element device, between the electric motor and the combustion engine, is disengaged during a combustion engine powered starting process and the shift element device, between the electric motor and the combustion engine, is engaged. Then, the drive torque, produced by the combustion engine, is passed by the hydraulic coupling element towards the drive output, while the frictional shift element of the shift element device, between the combustion engine and the electric motor, and the shift element device, between the electric motor and the drive output, can be operated without slip and, therefore, almost with no load.

In a further embodiment of the inventive method, for operating a drivetrain arrangement, the transmission capacity of the frictional shift element of the shift element device, between the combustion engine and the electric motor, is varied in an operating-condition-dependent manner during driving operation in which at least part of a required drive torque is delivered by the combustion engine and the shift element device, between the electric motor and the drive output, is disengaged so that the frictional shift element can be assigned the function of a so-termed converter bridging clutch and the hydraulic effect of the hydraulic coupling element on the drive behavior of the drivetrain arrangement can be varied depending on the operating situation.

During so-termed recuperative operation, a further embodiment of the inventive method is provided where the frictional shift element of the shift element device, between the combustion engine and the electric motor, is disengaged and the combustion engine is kept in an idling operating condition or switched off so that the electric motor is operated as a generator and the shift element device, between the electric motor and the drive output, is engaged. This ensures that all of the thrust torque applied by the drive output to the electric motor charges an electric accumulator, associated with the electric motor, and is not, even at least partially, passed to the combustion engine.

Moreover, in another advantageous embodiment of the inventive method, in a combustion-engine-driven operation of charging an electric accumulator associated with the electric motor during which the electric motor is operated as a generator and driven, by the combustion engine, at a drive output speed which is at least approximately zero, the shift element device between the electric motor and the drive output, is converted to slipping operation or completely disengaged and the frictional shift element is preferably operated in a fully engaged condition. This disengages the connection between the drive aggregates, i.e., the combustion engine and the electric motor and the drive output, in the area of the shift element device, between the electric motor and the drive output. The connection, between the combustion engine and the electric motor, acts without the hydrodynamic influence of the hydraulic coupling element at the same time the frictional shift element of the shift element device, between the combustion engine and the electric motor, is operated without slip, where the drive torque of the combustion engine is available essentially without loss for charging the electric accumulator.

If a starting process is called for during an electric accumulator charging operation when the vehicle is nearly or actually at rest, the frictional shift element is disengaged, between the combustion engine and the electric motor, and the shift element device, between the electric motor and the drive output, is being operated in the slipping mode or is completely disengaged according to an advantageous embodiment of the inventive method. During the starting process, the shift element device, between the electric motor and the drive output, is synchronized by varying the generator torque produced by the electric motor and is completely engaged when the synchronous speed is reached.

In a simple manner, this procedure enables the drivetrain arrangement to change to an operating condition, suitable for a vehicle starting process from an operation of charging the electric accumulator, associated with the electric motor, with only slight loading of the frictional shift element of the shift element device, between the electric motor and the combustion engine and of the shift element device, between the electric motor and the drive output. The vehicle starting process is then carried out also with only slight loading of the frictional shift element of the shift element device, between the combustion engine and the electric motor, and of the shift element device, between the electric motor and the drive output, since the drive torque produced by the combustion engine is transmitted in the direction of the drive output, via both the hydraulic coupling element and the shift element device, between the electric motor and the drive output, operating without slip.

In a further advantageous embodiment of the inventive method, the starting process of a vehicle, made with the inventive drivetrain arrangement, is carried out by the combustion engine with the disengaged frictional shift element of the shift element device, between the combustion engine and the electric motor, and with the engaged shift element device, between the electric motor and the drive output, when the amount of change of the electric accumulator associated with the electric motor, is too depleted for the electric motor alone to complete for a starting process.

### BRIEF DESCRIPTION OF THE DRAWINGS

The invention will now be described, by way of example, with reference to the accompanying drawings in which:

FIG. 1 is a schematic representation of a first embodiment of an inventive drivetrain arrangement comprising a combustion engine, an electric motor and a drive output such that there is a shift element device with variable transmission capacity between the combustion engine and the electric motor and between the electric motor and the drive output;

FIG. 2 is a further embodiment of the inventive drivetrain arrangement shown in FIG. 1 in which the shift element device, between the combustion engine and the electric motor, is made with two torsion dampers;

FIG. 3 is a third embodiment of the inventive drivetrain arrangement in which a transmission device, arranged between the electric motor and the drive output, is associated with a main transmission pump device and a further pump device that can be driven by another electric motor;

FIG. 4 is a representation of an inventive drivetrain arrangement with a torsion damper associated with the electric motor corresponding to FIG. 1;

FIG. 5 is a fifth embodiment of an inventive drivetrain arrangement with a structure alternative to the fourth embodiment shown in FIG. 4;

FIG. 6 is a sixth embodiment of an inventive drivetrain arrangement in which the main transmission pump device is in active connection, via a first free-wheel overrunning connection, with a coupling element side of a hydraulic coupling element, that is connected to the combustion engine and, via a second free-wheel overrunning connection, with a coupling element side of the hydraulic coupling element, that is connected to the transmission input shaft.

### DETAILED DESCRIPTION OF THE INVENTION

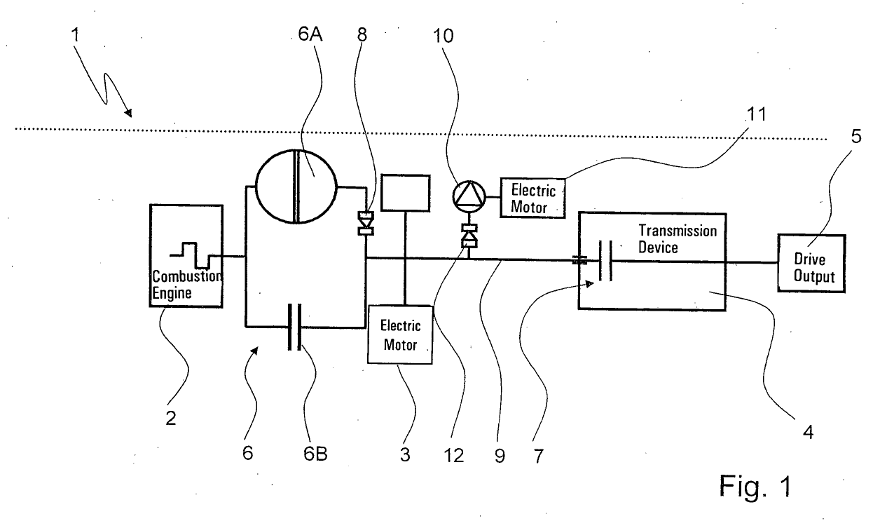

In a schematic form represented as a block diagram, FIG. 1 shows a drivetrain arrangement 1 of a hybrid vehicle made as a parallel hybrid drivetrain. The parallel hybrid drivetrain 1 comprises a combustion engine 2, an electric motor 3, a transmission device 4 and an output drive 5. A respective shift element device 6, 7, with continuously variable transmission capacity, is arranged between the combustion engine 2 and the electric motor 3 and between the electric motor 3 and the output drive 5, in each case.

The shift element device 6, between the combustion engine 2 and the electric motor 3, comprises a hydraulic coupling device 6A with a speed-dependent characteristic and a frictional shift element 6B, which is arranged in a power branch of the parallel hybrid drivetrain 1 that runs parallel to the hydraulic coupling element 6A, whose transmission capacity is continuously adjustable and by way of which the hydraulic coupling element 6A can be bridged. Furthermore, a coupling element side of the hydraulic coupling element 6A is in active connection with the electric motor 3, via a free-wheel overrunning connection 8. The active connection between the coupling element and the electric motor 3 or a transmission input shaft 9 of the transmission device 7, via the free-wheel overrunning connection 8, disengages when the speed of the coupling element side of the coupling element 6A, associated with the electric motor, is smaller than the speed of the electric motor 3 or the transmission input shaft 9 in the area of the free-wheel overrunning connection 8.

This means that the coupling element 6A can essentially only transfer a drive torque from the combustion engine 2 in the direction of the drive output 5, and when the parallel hybrid drivetrain 1 is in thrust operation, a torque from the combustion engine 2 can only be transferred if the transmission capacity of the frictional shift element 6B of the shift element device 6, between the combustion engine and the electric motor, is appropriate. In addition, a drive torque produced by the electric motor, during its operation in the motor mode, can only be transferred from the frictional shift element 6B to the combustion engine 2, for example, during an electric motor powered starting operation of the combustion engine 2, whereas a drive torque from the combustion engine, during traction operation of the parallel hybrid drivetrain 1, can be passed to the transmission input shaft 9, via the free-wheel overrunning connection 8, regardless of the transmission capacity of the frictional shift element at the time.

In this case, the hydraulic coupling element 6A is made as a so-termed Föttinger clutch although it is, of course, within the capability of a person with knowledge of the field to also make the coupling element 6A as a hydrodynamic torque converter or as a hydraulic clutch of some other type.

The shift element device 7, arranged between the electric motor 3 and the drive output 5 in the example embodiment of a parallel hybrid drivetrain 1 shown in FIG. 1, is made as a shift element of the transmission device 4 which, depending on the particular transmission system used, may be a frictional shift clutch or a frictional shift brake.

In the present case, a main transmission pump device 10 can be driven both by the transmission input shaft 9 and by a further electric motor 11. For this, the transmission input shaft 9 is actively connected to the main transmission pump device 10 or a pump impeller wheel, via another free-wheel overrunning connection 12, such that the other free-wheel overrunning connection 12 disengages when the speed of the pump impeller wheel of the main transmission pump device 10 is higher than the speed of the transmission input shaft 9. By way of the further electric motor 11, it is also possible to drive a part of the main transmission pump device 10 that must be driven in order for the main transmission pump device 10 to carry out its pumping function, so that even if the transmission input shaft 9 is at rest, the further electric motor 11 can power the main transmission pump device 10 to produce a control pressure for the shift elements of the transmission device 7 and for the frictional shift element 6B. A further free-wheel overrunning connection 12, between the transmission input shaft 9 and the main transmission pump 10, prevents any torque from being transferred from the further electric motor 11 to the transmission input shaft 9.

The further electric motor 11 is preferably a compact EC motor which can be made in the form of a space-saving plug-in unit, whereas the main transmission pump device is a mechanical oil pump optimized for efficiency, in relation to the diameter/width ratio of the pump, for the diameter of the transmission input shaft.

By way of the fact that the main transmission pump device 10 is in active connection both with the transmission input shaft 9 and with the further electric motor 11, the power availability of the vehicle is better compared with that provided by conventional drivetrain arrangements. This improvement comes into its own particularly in the event of a failure of the electric drive of the main transmission pump device 10, while there is still available energy in an electric accumulator associated with the electric motor 3 (not represented in the drawing), since the main transmission pump device 10 can be driven by the electric motor 3, via the transmission input shaft 9 so that the transmission device 4 and the frictional shift element 6B can be acted upon by a control pressure. In a simple manner, this enables, by adjusting the frictional shift element 6B, adjustment of a transmission capacity such that an emergency start of the combustion engine 2 is possible by the electric motor 3 and, in the transmission device 4, allows corresponding control of the transmission-internal shift elements, as required, for an emergency start of the vehicle.

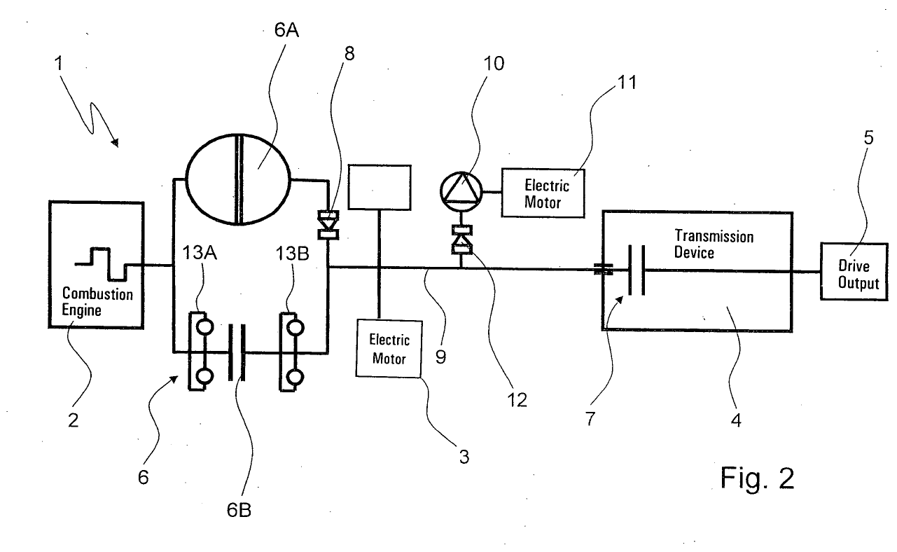

FIG. 2 shows a second embodiment of the parallel hybrid drivetrain 1 of a hybrid vehicle in the form of a block diagram representation, the parallel hybrid drivetrain 1 of FIG. 2 differs from the parallel hybrid drivetrain shown in FIG. 1 essentially only in the area of the shift element device 6, between the combustion engine 2 and the electric motor 3, so that the description which follows will concern only the differences between the two embodiments.

In the spans between the combustion engine 2 and the frictional shift element 6B and between the frictional shift element 6B and the electric motor 3, the parallel hybrid drivetrain 1 of FIG. 2 contains, in each case, a torsion damper 13A, 13B for damping rotation irregularities in the power path of the parallel hybrid drivetrain 1 such that, in further embodiments of the inventive parallel hybrid drivetrain (not specifically illustrated), it is provided that at least one torsion damper for damping rotation irregularities is arranged between the electric motor and the coupling element and/or the frictional shift element and/or between the combustion engine and the coupling element and/or the frictional shift element.

In this case, both the frictional shift element 6B and the torsion damping elements 13A and 13B are integrated in a housing of the hydraulic coupling element 6A and form a module with it, which can be fitted, when assembling the parallel hybrid drivetrain, during an assembly step, into the housing of the transmission device 4 in a structural space close to the electric motor and the main transmission pump device 10. Depending on the intended application, the free-wheel overrunning connection 8 can be arranged, between the hydraulic coupling element 6A and the transmission input shaft 9 or the electric motor 3, either inside or outside the housing of the hydraulic or hydrodynamic coupling element 6A.

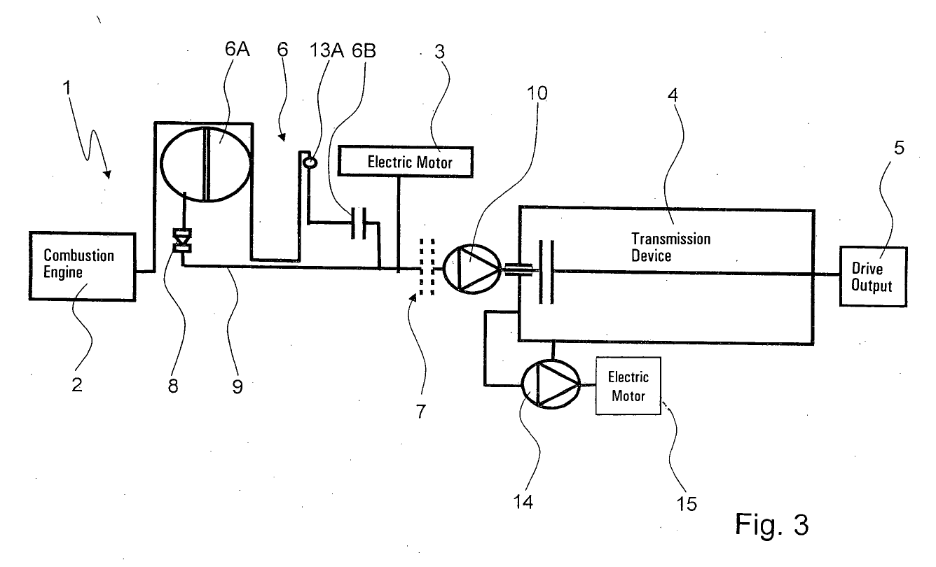

A third embodiment of the inventive parallel hybrid drivetrain 1 is shown in FIG. 3 such that in this embodiment the main transmission pump device 10 can only be driven by the transmission input shaft 9 and a further pump device 14 is associated with the transmission device 4 to deliver pressure to the shift elements of the transmission device 4 while the main transmission pump device 10 is not delivering.

Moreover, the shift element device 7, between the electric motor 3 and the drive output 5, is made as a frictional shift element located upstream from the transmission device 4, which is arranged in a structural space surrounded by the electric motor.

In contrast to the transmission-internal configuration of the shift element device 7, between the electric motor 3 and the drive output 5, the transmission-external arrangement of the shift element device 7 is subject to less restrictions in relation to its design as a slipping clutch during a starting process of the combustion engine and, in principle, shows gear- and shift-independent behavior during a process of starting the combustion engine. In addition, in principle, a process of starting the combustion engine, while a vehicle is driving in reverse, can be carried out by the same procedure as during a process of starting the combustion engine while the vehicle is driving forward where, with a transmission-internal arrangement of the shift element device 7, between the electric motor 3 and the drive output 5, the latter aspect demands additional design measures for its adoption.

In the present case, the further pump device 14 makes it possible to maintain a control pressure level in the hydraulic system of the transmission device 4, which is required for a purely electric-machine-powered starting process. This can be done with a low-power electric motor 15. Once the hybrid vehicle, made with the parallel hybrid drivetrain 1 according to FIG. 3 is rolling, pressure supply to the transmission device 4 is supported or taken over by the main transmission pump device 10 so that shifts can be carried out in the transmission device 4 even during purely electric-machine-powered driving.

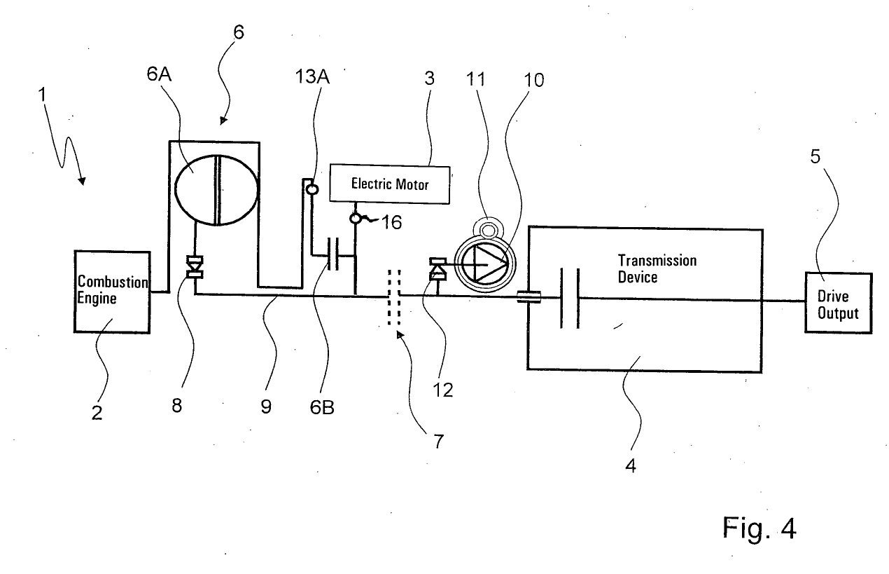

As the parallel hybrid drivetrain 1 of FIG. 1, the fourth embodiment is made with an electrically driven main transmission pump device 10, shown in FIG. 4, which is in active connection with the transmission input shaft 9, via the further free-wheel overrunning connection 12. Furthermore, in the same way as the parallel hybrid drivetrain of FIG. 3, according to FIG. 4, the parallel hybrid drivetrain 1 is made with the transmission-externally arranged shift element device 7, between the electric motor 3 and the output drive 5. In addition, a torsion damper 16 for rotation irregularity damping is associated with the electric motor 3, where the driving comfort can be further improved.

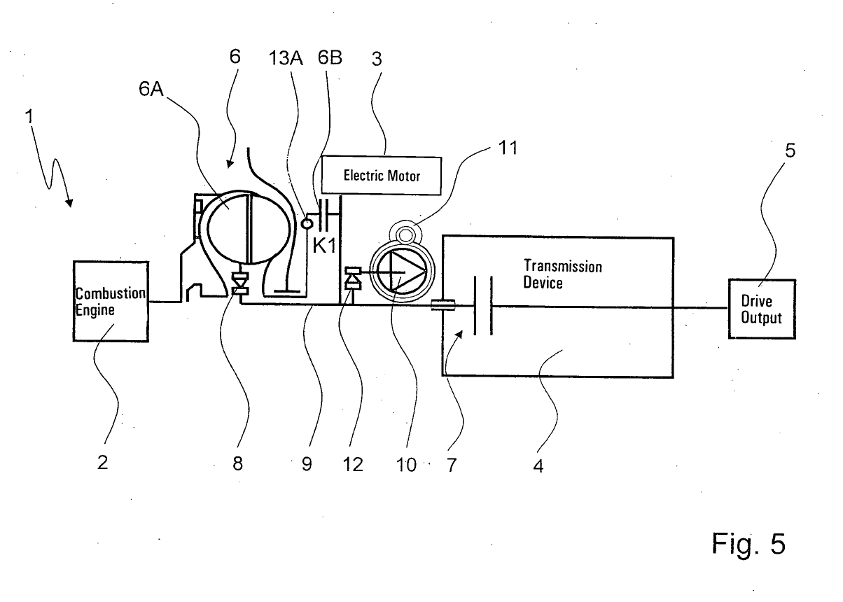

A fifth embodiment of a parallel hybrid drivetrain or drivetrain arrangement 1 made in accordance with the invention, shown in FIG. 5, differs from the fourth embodiment, shown in FIG. 4, essentially in that the shift element device 7, between the electric motor 3 and the drive output 5, is made in the form of a transmission-internal shift element and is thus characterized by less system complexity.

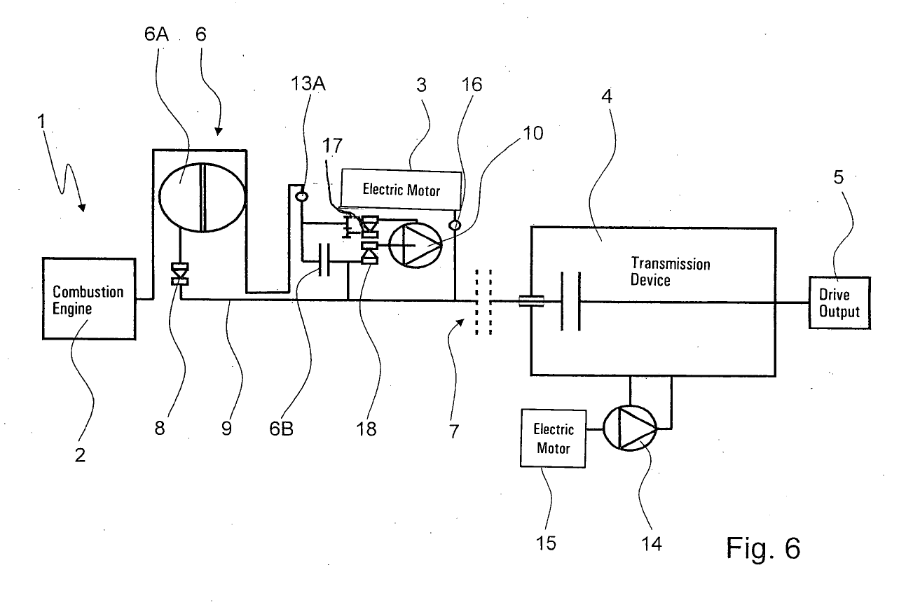

In a sixth embodiment of a parallel hybrid drivetrain or drivetrain arrangement 1, according to the invention shown in FIG. 6, a part of the main transmission pump device 10, required has to be driven for the main transmission pump device 10 to perform its delivery function. is in active connection, via a first respective free-wheel overrunning connection 17, with a coupling element side of the hydraulic coupling element 6B that is connected to the combustion engine 2 and, via a second respective free-wheel overrunning connection 18, with a coupling element side of the hydraulic coupling element 6A that is connected to the transmission input shaft 9. When the speed of the combustion engine 2 is higher than the speed of the transmission input shaft 9, the first free-wheel overrunning connection 17 is engaged, and when the speed of the combustion engine 2 is lower than the speed of the transmission input shaft 9 it is disengaged where, when the speed of the combustion engine 2 is higher than the speed of the transmission input shaft 9, the second free-wheel overrunning connection is disengaged and when the speed of the combustion engine 2 is lower than the speed of the transmission input shaft 9, it is engaged.

In a simple manner, this makes it possible to drive the main transmission pump device 10, in this case, made as an internal geared pump with dual free-wheel overrunning connection, respectively, at the higher speed of the combustion engine 2 or that of a turbine of the hydraulic coupling element 6A and with the coupling element side connected to the transmission input shaft 9. In addition. a transmission ratio step can be provided between one of the couplings of the oil pump.

In a further development of the parallel hybrid drivetrain 1 of FIG. 6 (not illustrated), it is provided that the main transmission pump device 10 is connected, via a third free-wheel overrunning connection, to a further electric motor by way of which, if no drive power is coming from the combustion engine 2 or the electric motor 3, it can be driven in order to produce a hydraulic control pressure for the transmission device 4 and/or for the shift element devices 6 and 7. When the main transmission pump device 10 is being driven by the combustion engine or by a turbine wheel the third free-wheel overrunning connection, between the main transmission pump device 10 and the additional electric motor, is disengaged, so that the delivery power of the main transmission pump device 10 will not be compromised by the further electric motor. In this embodiment, the further pump device 14 of the parallel hybrid drivetrain 1 is not needed, according to FIG. 6 where, in a simple manner, additional pipework, between the hydraulic system of the transmission device 4 and the pump device with the associated sealing problems, is avoided.

The shift element devices 6 and 7, respectively, between the combustion engine 2 and the electric motor 3 and between the latter and the drive output 5, can be made as dry clutches or as wet-running clutches that can be operated with slip for long periods, depending on the intended application in each case.

In all the embodiments of the inventive drivetrain arrangement 1, according to the invention represented in the drawings, the electric motor 3, the hydraulic coupling element 6A and the frictional shift element 6B of the shift element device 6, between the combustion engine 2 and the electric motor 3, are arranged in a common cooling circuit, preferably with the electric motor 3 upstream in the cooling circuit relative to the hydrodynamic coupling element 6A and the frictional shift element 6B. After flowing through the frictional shift element 6B, the cooling medium circulating in the cooling circuit can be passed into a fluid reservoir, preferably an oil sump of the transmission device 4, where the cooling circuit of the main transmission pump device 10 is supplied.

Furthermore, with a drivetrain arrangement formed, in principle, the same final assembly concept can be used as in the case of conventional drivetrain concepts comprising an engine/transmission connection with a hydrodynamic torque converter so that, for the construction of a drivetrain arrangement according to the invention, by production processes already in use, only slight changes need be made to the sequence concerned.

### REFERENCE NUMERALS

1 drivetrain arrangement, parallel hybrid drivetrain
2 combustion engine
3 electric motor
4 transmission device
5 drive output
6 shift element device
6A hydraulic coupling device
6B frictional shift element
7 shift element device
8 free-wheel overrunning connection
9 transmission input shaft
10 main transmission pump device
11 further electric motor
12 further free-wheel overrunning connection
13A torsion damper
13B torsion damper
14 further pump device
15 further electric motor
16 torsion damper
17 first free-wheel overrunning connection
18 second free-wheel overrunning connection

1-19. (canceled)

20. A parallel hybrid drivetrain arrangement (1) for a vehicle having a combustion engine (2), an electric motor (3) and a drive output (5), the drivetrain arrangement comprising:
a first shift element device (7) with a continuously variable transmission capacity being located between the electric motor (3) and the drive output (5);
a second shift element device (6) with a continuously variable transmission capacity being located between the combustion engine (2) and the electric motor (3), and having two parallel power branches, the second shift element device (6) comprises:
a hydraulic coupling element (6A) with a speed-dependent characteristic being located on one of the two parallel power branches for bridging the transmission capacity of the second shift element device (6);
a freewheel clutch connection (8) actively connecting a first coupling element side of the hydraulic coupling element (6A), associated with the electric motor, with the electric motor (3);
a frictional shift element (6B), located on another of the two parallel power branches, and the freewheel clutch connection (8) disengages when a speed of the first coupling element side of the hydraulic coupling element (6A), associated with the electric motor, is lower than a speed of the electric motor (3) in an area of the freewheel clutch connection (8).

21. The drivetrain arrangement according to claim 20, wherein at least one torsion damper (13A, 13B) is at least one of arranged between at least one of:
the hydraulic coupling element (6A) and the frictional shift element (6B) and the electric motor (3), and
the combustion engine (2) and at least one of the hydraulic coupling element (6A) and the frictional shift element (6B).

22. The drivetrain arrangement according to claim 20, wherein the hydraulic coupling element (6A) is one of a Föttinger clutch and a hydrodynamic torque converter.

23. The drivetrain arrangement according to claim 20, wherein the first shift element device (7) is a shift element of a transmission device (4) which is arranged between the electric motor (3) and the drive output (5).

24. The drivetrain arrangement according to claim 23, wherein a main transmission pump device (10) is driven by a transmission input shaft (9) of the transmission device (4) and by a further electric motor (11), the transmission input shaft (9) is actively connected, via a further freewheel clutch connection (12), with a part of the main transmission pump device (10) that must be driven for the main transmission pump device (10) to perform a delivery function, an the further freewheel clutch connection (12) disengages when a speed of the part of the main transmission pump device (10) is higher than a speed of the transmission input shaft (9).

25. The drivetrain arrangement according to claim 23, wherein a part of a main transmission pump device (10), that must be driven for the main transmission pump device (10) to perform the delivery function, is in active connection, via a second freewheel clutch connection (17), with a second coupling element side of the hydraulic coupling element, (6A) that is connected to the combustion engine (2), and, via a third freewheel clutch connection (18) with a coupling element side of the hydraulic coupling element (6A) that is connected to the transmission input shaft (9), such that the second freewheel clutch connection (17) is engaged when a speed of the combustion engine (2) is higher than a speed of the transmission input shaft (9) and is disengaged when the speed of the combustion engine (2) is lower than the speed of the transmission input shaft (9), the third freewheel clutch connection (18) is disengaged when the speed of the combustion engine (2) is higher than the speed of the transmission input shaft (9) and is engaged when the speed of the combustion engine (2) is lower than the speed of the transmission input shaft (9).

26. The drivetrain arrangement according to claim 25, wherein the main transmission pump device (10) is driven by another electric motor, and the second freewheel clutch connection (17) and the third freewheel clutch connection (18) are both disengaged when a drive speed of the other electric motor is higher than the speed of the combustion engine (2) and higher than the speed of the transmission input shaft (9).

27. The drivetrain arrangement according to claim 23, wherein a transmission device (4) is associated with a further pump device (14) that is driven by a further electric motor (15) for producing a hydraulic control pressure in a hydraulic control system of the transmission device (4).

28. The drivetrain arrangement according to claim 20, wherein the electric motor (3), the hydraulic coupling element (6A) and the frictional shift element (6B) share a common cooling circuit.

29. The drivetrain arrangement according to claim 28, wherein the electric motor (3) is arranged in the common cooling circuit upstream relative to the hydraulic coupling element (6A) and the frictional shift element (6B), and a cooling medium flows into an oil sump of the transmission device (4), after flowing through the frictional shift element (6B).

30. The drivetrain arrangement according to claim 28, wherein the main transmission pump device (10) supplies the common cooling circuit.

31. A method of operating a drivetrain arrangement (1) for a vehicle having a combustion engine (2), an electric motor (3) and a drive output (5), the drivetrain arrangement comprising a first shift element device (7), with a continuously variable transmission capacity, being located between the electric motor (3) and the drive output (5); a second shift element device (6), with a continuously variable transmission capacity, being located between the combustion engine (2) and the electric motor (3), and having two parallel power branches, the second shift element comprises: a hydraulic coupling element (6A) with a speed-dependent characteristic being located on one of the two parallel power branches for bridging the transmission capacity of the second shift element device (6); a freewheel clutch connection (8) actively connecting a first coupling element side of the hydraulic coupling element (6A), associated with the electric motor, with the electric motor (3); a frictional shift element (6B) located on another of the two parallel power branches; and the freewheel clutch connection (8) disengaging when a speed of the first coupling element side of the hydraulic coupling element (6A), associated with the electric motor, is lower than a speed of the electric motor (3) in the area of the freewheel clutch connection (8), the method comprising the steps of:
disengaging the frictional shift element (6B) of the second shift element device (6) during purely electric-machine-powered driving; and
engaging the first shift element device (7) located between the electric motor (3) and the drive output (5) during the purely electric-machine-powered driving.

32. The method of operating a drivetrain arrangement according to claim 31, further comprising the steps oft during a starting process of the combustion engine (2):
engaging the frictional shift element (6B) of the second shift element device (6) in a controlled and regulated manner; and
operating the first shift element device (7) in a slipping mode manner.

33. The method of operating a drivetrain arrangement according to claim 31, further comprising the steps of, during a starting process powered by the combustion engine,
disengaging the frictional shift element (6B) of the second shift element device (6); and
engaging the shift element device (7).

34. The method of operating a drivetrain arrangement according to claim 31, further comprising the step of, during a driving operation in which at least part
of a required drive torque is provided by the combustion engine (2), varying the transmission capacity of the frictional shift element (6B) of the second shift element device (6) in an operating-condition-dependent manner; and
engaging the first shift element device (7).

35. The method of operating a drivetrain arrangement according to claim 31, further comprising the step of, during a recuperative operation,
disengaging the frictional shift element (6B) of the second shift element device (6) and engaging the first shift element device (7); and
one of retaining and switching off the combustion engine (2) in an idling operation so that the electric motor (3) operates in a generator mode.

36. The method of operating a drivetrain arrangement according to claim 31, further comprising the step oft when charging an electric accumulator associated with the electric motor (3), changing the first shift element device (7) to one of a slipping operation and a disengaged condition, and operating the frictional shift element (6B) of the shift element device (6) in a completely engaged condition such that the electric motor (3) is operated as a generator and driven by the combustion engine (2) at a drive output speed which is approximately zero.

37. The method of operating a drivetrain arrangement according to claim 31, further comprising the step of, when a starting process is called for during a charging operation of the electric accumulator and when the vehicle is at least approximately at rest, and changing the first shift element device (7) to one of a slipping mode and a completely disengaged condition, disengaging the frictional shift element (6B) of the second shift element device (6), and synchronizing the first shift element device (7), during the starting process, by varying a generator torque of the electric motor (3) and completely engaging the first shift element device (7) when a synchronous speed is reached.

38. The method of operating a drivetrain arrangement according to claim 31, further comprising the step of, when a charge condition of an electric accumulator associated with the electric motor (3) is sufficiently depleted for solely an electric-machine-powered starting process, carrying out the starting process by disengaging the combustion engine (2), via the frictional shift element (6B) of the second shift element device (6), and engaging the combustion engine (2), via the shift element device (7).

39. A parallel hybrid drivetrain arrangement (1) for a vehicle having a combustion engine (2), an electric motor (3) and a drive output (5), the drivetrain arrangement comprising:
a first shift element device (7) with a continuously variable transmission capacity being located between the electric motor (3) and the drive output (5);
a second shift element device (6) with a continuously variable transmission capacity being located between the combustion engine (2) and the electric motor (3), and having two parallel power branches, the second shift element comprising:
a hydraulic coupling element (6A), having a speed-dependent characteristic, being located on one of the two parallel power branches for bridging the transmission capacity of the second shift element device (6);
a freewheel clutch connection (8) having a first side in communication with the hydraulic coupling element (6A) and a second side in communication with the electric motor (3), the first side of the freewheel clutch connection (8) and the second side of the freewheel clutch connection (8) being actively connectable; and
a frictional shift element (6B) located on another of the two parallel power branches, and the freewheel clutch connection (8) disengaging when a rotational speed of the first side of the freewheel clutch connection (8) is lower than a rotational speed of the second side of the freewheel clutch connection (8).
